(19) United States
(12) Patent Application Publication
(10) Pub. No.: US 2002/0198708 A1
(43) Pub. Date: Dec. 26, 2002

(54) Vocoder for a mobile terminal using discontinuous transmission

(76) Inventors: Robert A. Zak, Apex, NC (US); Madeleine Saikaly, Raleigh, NC (US)

Correspondence Address: COATS & BENNETT, PLLC, P O BOX 5, RALEIGH, NC, 27602, US

(21) Appl. No.: 09/886,778

(22) Filed: Jun. 21, 2001

(51) Int. Cl. G10L 15/20

(52) U.S. Cl. 704/233

(57) ABSTRACT

A mobile terminal includes a vocoder operative in a speech active mode and a speech inactive mode. In speech active mode, the mobile terminal encodes an input signal to generate a coded speech signal. In a speech inactive mode, the vocoder generates comfort noise parameters for transmission by the mobile terminal. During a FACCH-in-progress condition, override logic forces the vocoder into a speech active mode.

### BACKGROUND OF THE INVENTION

The present invention relates generally to mobile terminals for wireless communication networks and, more particularly, to a vocoder for a mobile terminal using discontinuous transmission.

Discontinuous transmission is a technique commonly used in mobile terminals to reduce interference. In conventional mobile communication networks, the mobile terminal transmits continuously on the uplink during a call. Normal conversation, however, contains a number of pauses between periods of speech when a person listens to the other party. When a mobile terminal user is not speaking, transmission of the radio signal is not required from an information point of view. With discontinuous transmission, pauses in normal speech are detected in order to suspend radio transmission for the duration of the pause. Discontinuous transmission is typically an optional feature that can be enabled or disabled by the network as required. When used, discontinuous transmission can reduce air traffic, reduce interference between users, and extend battery life in mobile terminals.

To implement discontinuous transmission, the speech coder or vocoder must be able to detect when speech is present or not and to indicate whether transmission of a frame is required. The process of detecting the presence of speech in an input signal is known as voice activity detection (VAD). When the input signal contains speech, VAD detects its presence and signals the speech coder to encode the speech normally, typically at a rate of 7.4 kb/s. This mode is often referred to as the speech active mode. Conversely, when the input signal does not contain speech, VAD indicates that speech is absent and speech coding is suspended until speech resumes.

Experience has shown that the sudden disappearance of noise at a receiving terminal can be greatly disturbing to the user at the receiving end of a communication link. To avoid this problem, there needs to be a minimum amount of background noise at the receiving terminal, even when speech is not being transmitted. Therefore, an artificial background noise, generally referred to as comfort noise, is typically generated by the receiving terminal when speech is not being transmitted from the transmitting mobile terminal. During pauses in speech, the transmitting mobile terminal analyzes the background noise and generates parameters, called comfort noise parameters, which characterize the background noise at the transmitting end of the communication link. These comfort noise parameters are regularly updated and transmitted to the receiving terminal to use in generating comfort noise.

In a digital mobile terminal operating in accordance with the Telecommunications Industry Association (TIA) and Electronics Industry Alliance (EIA) standard TIA/EIA-136, comfort noise parameters are sent from the transmitting mobile terminal to the receiving terminal on the Fast-Associated Control Channel (FACCH). The FACCH is a logical subchannel of the digital traffic channel that is also used by the mobile terminal to send control messages to the base station. A control message transmitted from the mobile terminal to the base station may span multiple words, with each word sent to the base station in a separate FACCH frame. There is no requirement in the TIA/EIA-136 standard that the frames of a multi-frame FACCH message be transmitted contiguously. However, the standard specifies that no part of one FACCH message may be inserted between frames of another FACCH message.

The condition that exists when the first frame of a multi-frame FACCH message is sent, but before the last frame of the same FACCH message is received, is referred to as a FACCH-in-progress condition. During a FACCH-in-progress condition, speech frames may be transmitted. However, transmission of a FACCH message containing comfort noise parameters (a CN FACCH frame) is not permitted, since the protocol stack would not handle the intervening CN FACCH frame properly.

### BRIEF SUMMARY OF THE INVENTION

The present invention relates to a vocoder for a mobile terminal using discontinuous transmission. The vocoder comprises a voice activity detector, a speech encoder, and a comfort noise analyzer. The voice activity detector determines whether speech is present in the input signal to the vocoder and generates a voice activity signal that is output to mode control logic. In normal operation, the decision of the voice activity detector determines the operating mode of the vocoder. In a speech active mode, the speech encoder codes the input signal to generate coded speech for transmission by the mobile terminal. In a speech inactive mode, the comfort noise analyzer analyzes the background noise in the input signal and generates comfort noise parameters for transmission by the mobile terminal. The coded speech and comfort noise parameters are passed by the vocoder to mode control logic, referred to herein as the DTX handler. The DTX handler formats the coded speech and comfort noise parameters into frames for transmission by the mobile terminal. The DTX handler also inserts control messages passed to it by a microcontroller into the transmit signal. The comfort noise parameters and control messages are transmitted to the base station on the Fast Associated Control Channel (FACCH).

Control messages inserted into the transmit signal by the DTX handler may comprise two or more FACCH frames. Some communication standards, such as TIA/EIA-136, do not require that all frames of a multi-frame FACCH message be transmitted contiguously. However, such standards typically prohibit the insertion of frames from one FACCH message between the frames of another FACCH message. During a FACCH-in-progress condition, speech frames may be transmitted. However, transmission of a FACCH message containing comfort noise parameters is not permitted during a FACCH-in-progress condition, since the protocol stack would not handle the intervening comfort noise FACCH frame properly.

According to the present invention, the vocoder may be forced to operate in a speech active mode by override logic. The override logic detects a FACCH-in-progress condition and generates an override signal when a FACCH-in-progress condition is detected. The override signal forces the vocoder to operate in a speech active mode so that the vocoder continues to generate coded speech frames even though speech may not be present. In one embodiment of the invention, the override signal is asserted only when the mobile terminal is operating in a normal mode and prevents the mobile terminal from transitioning to a low transmission mode during a FACCH-in-progress condition.

### BRIEF DESCRIPTION OF THE DRAWINGS

FIG. 1 is a functional block diagram of a mobile terminal in accordance with the present invention.

FIG. 2 is a timing diagram illustrating the various operating modes of the mobile terminal.

FIG. 3 is a functional block diagram of a source encoder according to the present invention.

FIG. 4 is a timing diagram illustrating the operation of the source encoder.

### DETAILED DESCRIPTION OF THE INVENTION

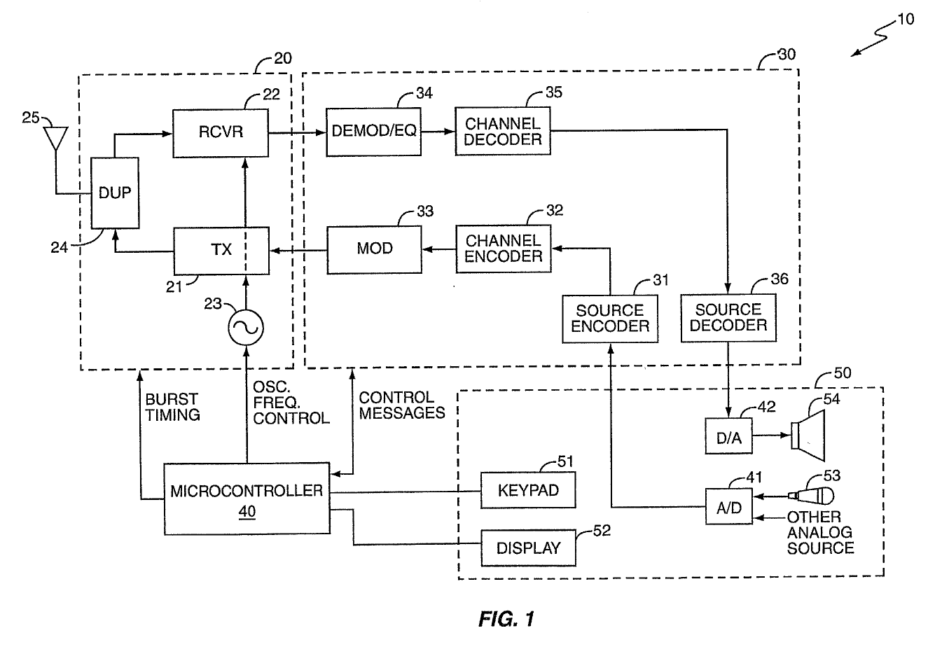

Referring now to the drawings, the present invention will be described in the context of a digital mobile terminal shown in FIG. 1 and indicated generally by the numeral 10. Mobile terminal 10 may comprise a cellular radiotelephone, a personal digital assistant that combines a cellular radiotelephone with a small hand-held computer, a wireless information terminal for wireless browsing on the Internet, a laptop or palmtop computer equipped with a wireless transceiver, or other mobile communication device 10. Mobile terminal 10 may also be referred to as a pervasive computing device.

Mobile terminal 10 comprises an RF section 20, a baseband section 30, a microcontroller 40, and a user interface 50. RF section 20 provides a wireless communication link to a base station in a Public Land Mobile Network (PLMN) and/or to other devices. Baseband section 30 processes signals transmitted and received by the mobile terminal 10. Microcontroller 40 controls the operation of the mobile terminal 10 and user interface 50 provides means for the user to interact with the mobile terminal 10.

RF section 20 comprises a transmitter 21, a receiver 22, and a frequency synthesizer 23. Transmitter 21 frequency converts baseband signals output from the digital baseband section 30 to the assigned transmit frequency to form transmit signals, then filters and amplifies the transmit signals. Receiver 22 filters and amplifies received signals and then frequency converts the received signals to baseband for processing by the digital baseband section 30. Frequency synthesizer 23 provides reference signals to the transmitter 21 and receiver 22 needed for frequency conversion. Transmitter 21 and receiver 22 couple to a shared antenna 25 via a duplex filter 24, which isolates the transmitter 21 and receiver 22 from one another.

Digital baseband section 30 processes signals transmitted and received by the mobile terminal 10. Baseband processing may include, for example, signal processing operations such as source coding/decoding, channel coding/decoding, interleaving/deinterleaving, modulation/demodulation, and encryption/decryption. Not all of these operations are required. In the exemplary mobile terminal 10 of FIG. 1, digital baseband section 30 comprises a source encoder 31, channel encoder 32, and modulator 33 in the transmit path, and further comprises a demodulator 34, channel channel decoder 35, and source decoder 36 in the receive path.

An information signal to be transmitted by the mobile terminal 10 is input to the source encoder 31. The information signal is assumed to be in a digitized format. If the information source is from an analog source, the information signal may be digitized by an analog-to-digital converter 41 before inputting the information signal to the source encoder 31. Source encoder 31 removes redundancy and randomizes the source information, producing an information sequence which has been optimized for maximum information content. The information sequence from the source encoder 31 is passed to the channel encoder 32.

Channel encoder 32 encodes the information sequence to introduce an element of redundancy into the information sequence. While initially appearing at odds with the function of the source encoder 31, the redundancy added by the channel encoder 32 can be used by the receiving terminal at the receiving end of the communication link to overcome the effects of noise and interference encountered during transmission of the signal through the communication channel. By introducing redundant information into the information sequence in a controlled manner, a receiving terminal can detect and correct errors that may occur during transmission of the signal through the communication channel.

Modulator 33 receives coded output from the channel encoder 32 and generates waveforms that can be efficiently transmitted over the communication channel. Coded bits output from the channel encoder 32 are grouped into symbols that are mapped to a corresponding waveform. The term “signal constellation” is often used to refer to the set of possible signal waveforms. These signal waveforms, or signal constellation schemes, are generally selected with regard to either simplification of the communication system, optimal detection performance, power requirements, or bandwidth availability. Typical signal constellations used in digital communication systems include 16-QAM, 8-PSK, and 4-PSK. The signal waveforms output from the modulator 33 are then modulated onto an RF carrier by transmitter 21 as previously described.

Received signals are processed by demodulator 34, channel channel decoder 35, and speech decoder 36. In general, signals transmitted over a communication channel from a source to a destination are corrupted by noise, fading, interference, and other adverse effects of the communication channel. The channel corrupted signal is received by receiver 22 and converted to baseband for processing by the digital baseband section 30. Digital baseband section 30 processes the received signals to recover the original information signal.

The received signal is input to demodulator 34 which processes the received signal to recover the symbols transmitted over the communication channel. The input to demodulator 34 is a sequence of corrupted signal waveforms corresponding to the transmitted symbols. Demodulator 34 converts the signal waveforms to a digital bitstring by reverse mapping the signal waveforms to a corresponding transmit symbol. For example, when binary modulation is used, the modulator 34 processes the received signal waveform during each symbol period and decides whether the transmitted symbol is a “0” or “1.” The bit sequence output from the demodulator 34 is referred to herein as the received sequence. Demodulator 34 may include an equalizer to compensate for amplitude and phase distribution. Ideally, the received sequence output from the demodulator 34 would be the same as the input sequence to the modulator 33 at the transmit end of the communication link. In actual practice, the communication channel distorts the transmitted signal so that the received sequence output from the demodulator 34 is likely to contain some bit errors.

The received sequence output from the demodulator 34 is passed to channel decoder 35, whose function is to detect and correct bit errors that may have occurred during transmission. Channel decoder 35 may, for example, comprise a Maximum Likelihood Sequence Estimation (MLSE) decoder, such as a Viterbi decoder. Channel decoder 35 attempts to reconstruct the original information sequence based on a priori knowledge of the coding scheme used by the channel encoder 32 at the transmit end of the communication link. The output of channel decoder 35 is an estimate of the original information sequence transmitted to the mobile terminal 10. In the absence of decoding errors, the estimate of the information sequence output from channel decoder 35 will be an exact replica of the information sequence output from the source encoder 31 at the transmit end of the communication link. A measure of how well the demodulator 34 and channel decoder 35 perform is the frequency with which bit errors occur in the estimated information sequence.

As a final step, source decoder 36 receives the estimated information sequence from channel decoder 35 and, from knowledge of the source encoding method, attempts to reconstruct the original information signal produced at the source. The difference between the reconstructed information signal and the original information signal is a measure of the distortion introduced by the communication system. If the original information signal was an analog signal, the output from the source decoder 36 may be converted to analog form by a digital to analog converter 42.

Microcontroller 40 controls the operation of the mobile terminal 10. The functions performed by the microcontroller include, for example, synchronization, frame timing, power control, channel selection, and a host of other functions as is well known in the art. To perform these functions, the microcontroller 40 exchanges signaling messages (also called control messages) with a base station or network. Control messages transmitted to the base station or network by the mobile terminal 10 are prepared by the microcontroller 40 and passed to the digital baseband section 30 for insertion into the transmitted signals. Control messages received from the base station or network are extracted from the received signals by the digital baseband section 30 and passed to the microcontroller 40 for processing. Microcontroller 40 also generates frame timing and frequency control signals to the RF section 20.

User interface 50 comprises a keypad 51 and display 52. Keypad 51 enables the user to enter commands and data into the mobile terminal 10 and select options when prompted. Display 52 allows the user to view information, such as stored data, user prompts, and output from various applications. The keypad 51 and display 52 together provide a means for the user to interact with the mobile terminal 10 and to control its operation.

User interface 50 further comprises an audio interface including a microphone 53 and speaker 54. Microphone 53 converts speech and other audible sounds into an analog signal which can then be digitized by analog-to-digital converter 41 for transmission or processing by the mobile terminal 10. Signals containing speech or other audio may be converted to audible sounds by speaker 54. Digitized speech and audio may be converted to an analog signal by digital-to-analog converters 42 and output to speaker 54 which converts the analog signals to audible sounds that can be heard by the user.

The mobile terminal 10 according to the present invention may, for example, implement the Telecommunications Industry Association (TIA)/Electronics Industry Alliance (EIA) standard TIA/EIA-136, which is incorporated herein by reference. The TIA/EIA-136 standard is a time division multiple access (TDMA) standard for cellular and personal communication services (PCS) networks. The present invention may also have utility in a cellular/PCS communication network based on Code Division Multiple Access (CDMA), such as IS-95, cdma2000, and Wideband CDMA (W-CDMA). The remainder of this specification will, however, focus on an exemplary embodiment particularly adapted for use in a TIA/EIA-136 cellular/PCS network.

Discontinuous transmission (DTX) is a technique used to reduce overall interference in the air interface and to conserve power in mobile terminals 10. A conventional mobile terminal transmits continuously on the uplink whenever a call is in progress. Continuous transmission on the uplink, however, is inefficient since normal speech contains a number of pauses, for example, when the mobile terminal user is not speaking. Continuing transmission during such pauses conveys no useful information. The concept underlying DTX is to reduce interference and conserve power by switching off the transmitter during periods when speech is not present.

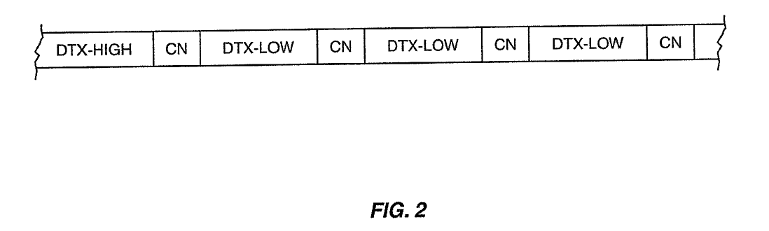

When DTX is enabled, the mobile terminal 10 switches between a normal transmission mode (DTX High) when the mobile terminal 10 transmits normally, and a low transmission mode (DTX Low) when radio transmission from the mobile terminal 10 is reduced. FIG. 2 illustrates the operation of the mobile terminal 10 when DTX is enabled. In normal transmission mode (DTX High), one speech frame of 260 bits is transmitted every 20 ms. In low transmission mode (DTX Low), one speech frame of 260 bits is transmitted each 480 ms. This lower transmission rate allows transmission of the CN parameters, as hereinafter described.

A potential problem when DTX is enabled is that the background acoustic noise, which is transmitted together with the speech, disappears when the radio transmission is switched off, resulting in discontinuities of the background noise at the receiving end of the communication link. The sudden disappearance of sound at the receiving end of the communication link can confuse or annoy the listener, particularly in environments with high background noise levels. In some cases, the listener may assume that the communication link has been lost and hang up. To overcome this problem, a receiving terminal may synthesize comfort noise similar to the transmit side background noise. Comfort noise (CN) parameters are typically estimated by the transmitting mobile terminal 10 and transmitted to the receiving terminal before transitioning from DTX High to the DTX Low mode. The CN parameters are used by the receiving terminal to generate comfort noise when no speech is received. After transitioning to the DTX Low mode, the CN parameters are regularly updated and transmitted to the receiving terminal to adapt to changes in the background noise at the transmit end of the communication link.

In a TIA/EIA-136 system, the CN parameters are transmitted by the transmitting mobile terminal 10 on the Fast-Associated Control Channel (FACCH). The FACCH is also used to transmit layer-3 control messages between the mobile terminal 10 and base station. That is, a layer-2 FACCH frame may be used to transport both control messages and CN parameters from the mobile terminal 10 to a serving base station. Messages transmitted by the mobile terminal 10 on the FACCH are referred to herein generically as FACCH messages. A single control message may require two or more layer-2 FACCH frames for transmission. In this case, the control message may be segmented and placed into two or more layer-2 FACCH frames. A FACCH message transmitted in two or more frames is referred to herein as a multi-frame FACCH message. There is no requirement in the TIA/EIA-136 standard that all of the frames of a single FACCH message be transmitted contiguously. Speech frames, for example, may be transmitted between layer-2 FACCH frames comprising a single FACCH message. However, transmission of a FACCH message containing CN parameters (a CN FACCH) is not permitted during a FACCH-in-progress condition since the protocol stack would not handle the intervening CN FACCH frame properly. A FACCH-in-progress condition is the condition that exists when the first frame of a multi-frame FACCH message has been sent but before the last frame of the same FACCH message has been received.

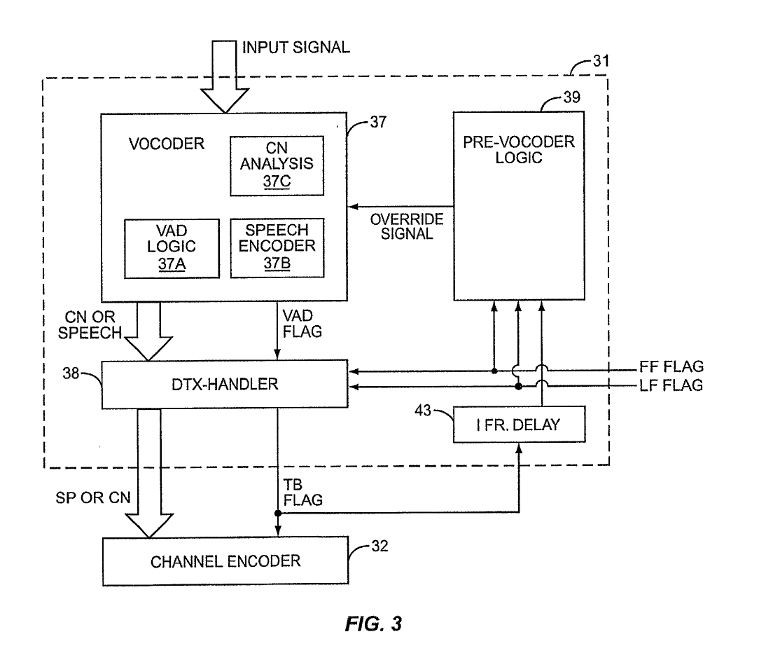

The present invention provides a method of detecting FACCH-in-progress conditions in DTX High mode and postponing CN parameter generation until transmission of the pending FACCH message is complete. The method according to the present invention will be explained with reference to FIG. 3, which comprises a functional block diagram of a source encoder 31 in a transmitting mobile terminal 10. Source encoder 31 comprises a vocoder 37, DTX handler 38, and pre-vocoder logic 39. The functions performed by vocoder 31 include speech encoding, voice activity detection (VAD), and comfort noise (CN) analysis. DTX handler 38 and pre-vocoder logic 39 comprise the logic for controlling DTX operations. These functions are described in greater detail below.

Vocoder 37 comprises voice activity detection (VAD) logic 37A, a speech encoder 37B, and comfort noise (CN) analysis logic 37C. Vocoder 37 has two operating modes: a speech active mode and a speech inactive mode. VAD logic 37A determines whether the input signal to the vocoder 37 for transmission contains speech. VAD logic 37A outputs a voice activity signal, referred to herein as the VAD flag, to the DTX handler 38. The VAD flag is set to “1” when speech is detected and is otherwise set to “0.” In normal operation, the VAD logic 37A determines the operating mode (i.e., speech active or speech inactive) of the vocoder 37. The decision of the vocoder 37 may be overridden as will be described below.

Speech encoder 37B encodes speech at a rate of 7.4 kb/s in a speech active mode when speech is present, and at the rate of about 1900 bits per second in a speech inactive mode when speech is not present. CN analysis logic 37C analyzes the input signal and generates CN parameters for transmission in a speech inactive mode when speech is not present.

At the end of a speech burst (transition of VAD flag=“1” to VAD flag=“0”), it takes seven consecutive frames to make an updated set of CN parameters available. Therefore, the vocoder 37 continues to encode speech at a rate of 7.4 kb/s for a period of six frames, referred to herein as the hang-over period, following the end of a speech burst. During this hang-over period, the CN analysis logic 37C can generate CN parameters which are output in the seventh frame following the end of the speech burst. The mobile terminal 10 goes into the DTX Low mode after transmitting the first set of CN parameters, which typically takes only one frame. If, however, at the end of a speech burst, less than 24 frames have elapsed since the last set of CN parameters was completed and passed to the radio transmitter, then the last set of CN parameters may be repeatedly passed to the radio transmitter until a new updated set of CN parameters is available. Once the mobile terminal 10 is in the DTX Low mode, the CN parameters are regularly updated by vocoder 37 and transmitted to the receiving terminal as long as the VAD flag remains equal to “0.”

Coded speech and/or comfort noise parameters are output from vocoder 37 to the DTX handler 38, depending on the decision of VAD logic 37A. DTX handler 38 formats coded speech and comfort noise parameters output by vocoder 37 into frames for transmission. DTX handler 38 also functions as a mode control logic to switch the mobile terminal between normal transmission mode and low transmission mode. Each frame includes a speech (SP) flag indicating whether the frame is a speech frame. The SP flag is set to “1” for speech frames, and otherwise it is set to “0.” When the VAD flag equals “1,” the vocoder output frame is passed by the DTX handler 38 directly to the radio transmitter with the SP flag equal to “1.” Also, SP flag is set equal to “1” for the six frames transmitted during the hang-over period following a speech burst. The mobile terminal 10 transitions from DTX High to DTX Low after transmitting the first set of CN parameters (i.e., when SP flag=“0”). DTX handler 38 generates a truncated burst (TB) flag, also referred to as a mode signal, indicating when the mobile terminal 10 is in discontinuous (DTX Low) mode. The TB flag is set equal to “1” in DTX Low mode. The TB flag is fed back to the pre-vocoder logic 39 through a one frame delay element 43.

Pre-vocoder logic 39 comprises logic for detecting a FACCH-in-progress condition and generating an override signal that is input to vocoder 37. Layer-2 frames containing control messages are passed from the microcontroller 40 to the pre-vocoder logic 39. Each frame has header information, such as a FACCH frame (FF) flag and last FACCH (LF) flag. The FF flag indicates the type of frame passed from the microcontroller 40. FACCH frames containing control messages have the FF flag set equal to “1.” The LF flag is used to signal a FACCH-in-progress condition. The LF flag is set to “0” when the first frame of a multi-frame FACCH message is passed from the microcontroller 40 to the pre-vocoder logic 39, and is set equal to “1” when the last frame is passed from the microcontroller 40 to the pre-vocoder logic 39.

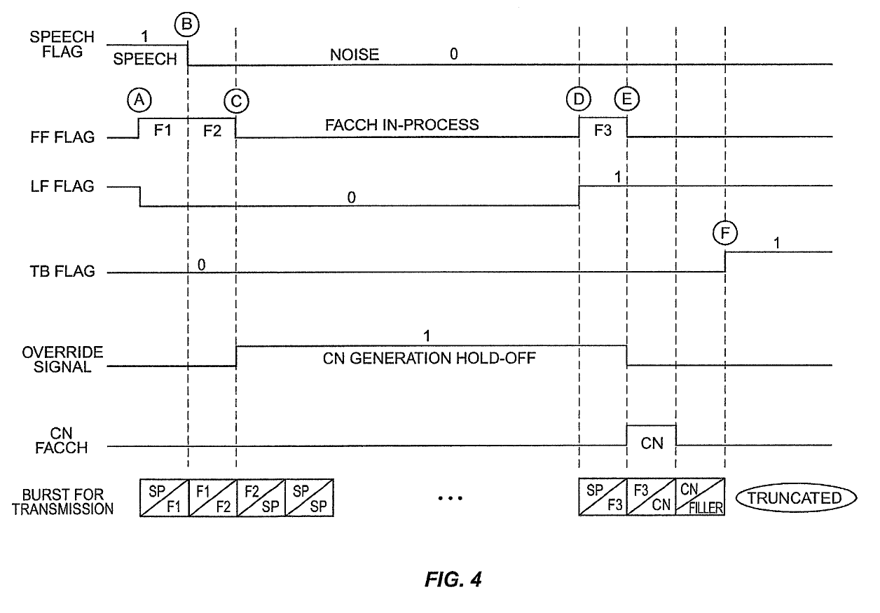

In operation, the pre-vocoder logic 39 generates an override signal to interrupt CN parameter generation during a FACCH-in-progress condition when the mobile terminal 10 is in the DTX High state (TB flag=“0”). The operation of the pre-vocoder logic 39 is shown in FIG. 4. A FACCH frame is transmitted at A containing a portion of a control message. The control message comprises three FACCH frames, denoted F1, F2, and F3. The FF flag transitions from “0” to “1” and the LF flag transitions from “1” to “0” at A. The truncated burst (TB) flag from the DTX handler 38 is in a low state, indicating that mobile terminal 10 is operating in normal (DTX High) mode.

The first two FACCH frames, F1 and F2, are transmitted contiguously. At point B, the SP flag transitions from “1” to “0,” which would normally cause the mobile terminal 10 to transition from normal transmission mode to low transmission mode. This transition is prevented, however, by the present invention because of a pending FACCH-in-progress condition at the time of the transition.

Transmission of the second FACCH frame, F2, ends at point C and the FF flag transitions from “1” to “0.” At this point, the override signal output from the pre-vocoder logic 39 to the vocoder 37 transitions from “0”” to “1.” A logical high indicates to the vocoder 37 that a FACCH-in-progress condition exists and that generation of CN parameters should be suspended. In a conventional mobile terminal 10, the CN analysis logic 37C generates CN parameters whenever VAD logic 37A indicates that speech is not present (when VAD flag=“0”). The override signal from the pre-vocoder logic 39, in effect, overrides the decision of VAD logic 37A during a FACCH-in-progress condition so that generation of CN parameters is temporarily halted. When the override signal is asserted, vocoder 37 is forced into a speech active mode and the vocoder 37 continues to encode speech at the normal rate of 7.4 kb/s.

At point D, the last FACCH frame, F3, is transmitted. At this point, both the FF flag and LF flag transition from “0” to “1.” At point E, transmission of the last FACCH frame, F3, is complete and the FF flag transitions from “1” to “0.” At this point, the TB flag is still low and the override signal output by the pre-vocoder logic 39 transitions from “1” to “0” allowing normal generation of CN parameters. Note that the override transitions from “1” to “0” when both the FF flag and TB flag are at a logical low and the LF flag is at a logical high. Once transmission of the CN frame is completed, the TB flag transitions from “0” to “1” at point F to indicate that the mobile terminal 10 is in a DTX Low mode.

In the disclosed embodiment, the override signal is not asserted at the beginning of the FACCH-in-progress condition. Instead, the override signal is asserted at the beginning of the third frame after the LF signal transitions from a logical high to a logical low because the first two frames are part of the same FACCH message. It is assumed that the logic of the DTX handler 38 can prioritize FACCH frames for transmission when two or more FACCH frames are presented for transmission. In this case, it is expected that the DTX handler 38 will schedule the first two FACCH frames for transmission prior to the CN FACCH. In this case, if all of the frames of a multi-frame FACCH message are transmitted contiguously, assertion of the override signal is unnecessary. However, one could assert the override signal at the beginning of a FACCH-in-progress condition (i.e., at the beginning of the first FACCH frame).

Also, it should be noted that the override signal is asserted only when the mobile terminal 10 is in a normal transmission mode (DTX High). This situation may occur, for example, when the SP flag transitions from a logical high to a logical low after the first frame of a multi-frame FACCH message has been transmitted. According to the TIA/EIA-136 standard, the mobile terminal 10 must transmit a CN FACCH prior to transitioning from normal transmission mode (DTX High) to low transmission mode (DTX Low). As shown in FIG. 4, this transition occurs during a FACCH-in-progress condition. Therefore, the mobile terminal 10 is unable to transmit the CN FACCH. As soon as there is no speech frame to transmit, and transmission of the CN FACCH is prohibited, there is no information to transmit. The present invention avoids this conundrum by forcing the vocoder 37 into a speech active mode, which simply causes the vocoder 37 to encode background noise as speech.

It is not necessary to override the decision of the VAD logic 37A when the mobile terminal 10 is operating in a low transmission mode (DTX Low). In this case, the receiving terminal has already received at least one set of CN parameters which it may use to generate comfort noise during silent periods. The receiving terminal can continue using the previously-received CN parameters until an updated set of parameters is transmitted. If desired, however, the override decision could be asserted even when the mobile terminal 10 is already in a low transmission mode, which would cause the mobile terminal 10 to transition to normal transmission mode.

The present invention applies to any digital cellular communication system where DTX compatibility is implemented in speech encoding blocks. Though described in the context of a TIA/EIA-136 communication system, the present invention may be used in systems that employ other standards, such as the global system for mobile communications (GSM). The present invention may also have utility in systems that employ code division multiple access standards, such as the IS-95 and IS-2000 standards.

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A source encoder for a mobile terminal comprising:
a vocoder normally operative in a speech active mode when speech is present and a speech inactive mode when speech is not present, said vocoder comprising:
a voice activity detector to detect the presence of speech in an input signal;
a speech encoder responsive to a decision of said voice activity detector to generate coded speech in said speech active mode; and
a comfort noise analyzer responsive to a decision of said voice activity detector to generate comfort noise parameters in said speech inactive mode;
override logic operatively connected to said vocoder to generate an override signal that overrides said decision of said voice activity detector and forces said vocoder into said speech active mode when speech is not present.

2. The source encoder of claim 1 wherein said override logic comprises logic to detect a FACCH-in-progress condition and to generate said override signal during said FACCH-in-progress condition.

3. The source encoder of claim 2 wherein said override logic detects said FACCH-in-progress condition based on examination of header information in FACCH messages transmitted by said mobile terminal.

4. The source encoder of claim 3 wherein said override logic detects said FACCH-in-progress condition by examining at least first and second flags in said FACCH messages, wherein said first flag is indicative of a FACCH message and said second flag is indicative of a FACCH-in-progress condition.

5. The source encoder of claim 4 further comprising mode control logic operatively connected to said vocoder and responsive to a voice activity signal from said vocoder to switch said mobile terminal between a normal transmission mode and a low transmission mode.

6. The source encoder of claim 5 wherein said mode control logic generates a mode signal indicative of whether said mobile terminal is operating in a normal transmission mode or a low transmission mode.

7. The source encoder of claim 6 wherein said override logic is responsive to said mode signal to generate said override signal when said mobile terminal is operating in said normal transmission mode.

8. The source encoder of claim 5 wherein said vocoder generates a voice activity signal indicative of the presence or absence of speech in said input signal.

9. The source encoder of claim 8 wherein said mode control logic is responsive to said voice activity signal from said vocoder to switch said mobile terminal between said normal transmission mode and said low transmission mode.

10. The source encoder of claim 9 wherein said vocoder generates a voice activity signal indicative of speech being present in response to said override signal.

11. In a mobile terminal comprising a vocoder operative in a speech active mode and a speech inactive mode, a method of coding an input signal comprising:
coding said input signal to generate coded speech for transmission by said mobile terminal in said speech active mode;
analyzing said input signal to generate comfort noise parameters for transmission by said mobile terminal in said speech inactive mode;
detecting a FACCH-in-progress condition; and
generating an override signal during a FACCH-in-progress condition to force said vocoder to operate in said speech active mode when speech is not present.

12. The method of claim 11 wherein detecting said FACCH-in-progress condition comprises examining header information in FACCH messages transmitted by said mobile terminal.

13. The method of claim 12 wherein detecting said FACCH-in-progress condition comprises examining at least first and second flags within said FACCH messages, wherein said first flag is indicative of a FACCH message and said second flag is indicative of a FACCH-in-progress condition.

14. The method of claim 13 further comprising detecting whether said mobile terminal is operating in a normal transmission mode or a low transmission mode.

15. The method of claim 14 wherein generating said override signal during a FACCH-in-progress condition to force said vocoder to operate in said speech active mode is performed only when said mobile terminal is operating in said normal transmission mode.

16. The method of claim 11 further comprising generating a voice activity signal by said vocoder indicative of the presence or absence of speech.

17. The method of claim 16 further comprising switching said mobile terminal between said normal transmission mode and said low transmission mode dependent upon said voice activity signal.

18. The method of claim 17 further comprising generating a voice activity signal indicative of speech being present in response to said override signal.

19. A mobile terminal comprising:
a transceiver to transmit and receive signals;
a vocoder connected to said transceiver normally operative in a speech active mode when speech is present and a speech inactive mode when speech is not present, said vocoder comprising:
a voice activity detector to detect the presence of speech in an input signal;
a speech coder responsive to a decision of said voice activity detector to generate coded speech in said speech active mode; and
a comfort noise analyzer responsive to a decision of said voice activity detector to generate comfort noise parameters in said speech inactive mode;
override logic operatively connected to said vocoder to generate an override signal to override said decision of said voice activity detector and to force said vocoder into said speech active mode when speech is not present.

20. The mobile terminal of claim 19 wherein said override logic comprises logic to detect a FACCH-in-progress condition and to generate said override signal during a FACCH-in-progress condition.

21. The mobile terminal of claim 20 wherein said override logic detects said FACCH-in-progress condition based on examination of header information in FACCH messages transmitted by said mobile terminal.

22. The mobile terminal of claim 21 wherein said override logic detects said FACCH-in-progress condition by examining at least first and second flags in said FACCH messages, wherein said first flag is indicative of a FACCH message and said second flag is indicative of a FACCH-in-progress condition.

23. The mobile terminal of claim 22 further comprising mode control logic operatively connected to said vocoder and responsive to a voice activity signal from said vocoder to switch said mobile terminal between a normal transmission mode and a low transmission mode.

24. The mobile terminal of claim 23 wherein said mode control logic generates a mode signal indicative of whether said mobile terminal is operating in a normal transmission mode or a low transmission mode.

25. The mobile terminal of claim 24 wherein said override logic is responsive to said mode signal to generate said override signal when said mobile terminal is operating in said normal transmission mode.

26. The mobile terminal of claim 23 wherein said vocoder generates a voice activity signal indicative of the presence or absence of speech in said input signal.

27. The mobile terminal of claim 26 wherein said mode control logic is responsive to said voice activity signal from said vocoder to switch said mobile terminal between said normal transmission mode and said low transmission mode.

28. The mobile terminal of claim 27 wherein said vocoder generates a voice activity signal indicative of speech being present in response to said override signal.
